(19) United States
(12) Patent Application Publication
(10) Pub. No.: US 2003/0074605 A1
(43) Pub. Date: Apr. 17, 2003

(54) Computer system and method for program execution monitoring in computer system

(75) Inventors: Yoshiaki Morimoto, Kawasaki (JP); Motoaki Satoyama, Sagamihara (JP); Shigeru Santo, Yokohama (JP); Masaki Nakano, Machida (JP); Kouji Doi, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/199,523

(22) Filed: Jul. 19, 2002

(30) Foreign Application Priority Data
Oct. 11, 2001 (JP) 2001-313791

(51) Int. Cl. H02H 3/05; G06F 9/44

(52) U.S. Cl. 714/38; 717/127

(57) ABSTRACT

In the invention, an exception that occurs in execution of a program is detected, and the normal operation exception occurrence pattern and/or the exception occurrence distribution are prepared from detected exceptions. Furthermore, by comparing the exception occurrence pattern and/or the exception occurrence distribution with the exception that is detected in operation of a computer, the abnormal operation is detected in early stage.

### BACKGROUND OF THE INVENTION

This invention relates to a method for monitoring execution of a program that is executed on a computer.

A tool called as de-bugger has been used for debugging work in which errors are detected and removed after preparation of a computer program heretofore. A debugger is capable of tracing the execution of a program and detecting error points based on the state that remains when the abnormality ends. It is required that a computer system built on the premise of the debugger that the program execution speed slows down when a debugger is used according to the inherent function of the debugger and a program to be debugged is not optimized is used.

Therefore, it is difficult to apply a debugger to monitor the program execution during “operation” of a program for providing the service. To avoid the above-mentioned problem, Japanese Published Laid-Open No. Hei 5-241886 that collects the data required for debugging in a database when an error occurs and presents it to a programmer after program finishes to support debugging is disclosed for the operation to be used separately from a debugger.

Furthermore, a method in which the system condition is seized by monitoring the program execution system itself and by monitoring the resource consumption such as memory and thread is proposed.

However, the information for debugging is obtained but the stability during operation cannot be improved directly only by obtaining debugging information when an error occurs. In the case of the method for monitoring the resource consumption of a computer, it is possible to detect some change that is likely premonition of abnormality. However, it is not discriminated whether the change is a normal change or a change due to abnormality of a program. Accordingly, it has been difficult to monitor automatically.

### BRIEF SUMMARY OF THE INVENTION

It is the object of the present invention to provide a program execution environment that is capable of debugging easily even when an error occurs and execution of a program stops in program monitoring during operation by means of a process in which a cause that will cause abnormality of the program is detected in the early stage before the abnormality ends and a spare computer is made ready for operation support if necessary to operate the program execution as continuously as possible, and by means of a process in which the program execution information that will be required for debugging work after the error ends is provided to a manager.

According to the present invention, a computer system comprises an exception detection section for detecting an exception that occurs when a program is executed, and an information output section for preparation of a normal operation exception occurrence pattern and/or exception occurrence distribution from the exception transmitted from the exception detection section.

### BRIEF DESCRIPTION OF THE SEVERAL VIEWS OF THE DRAWING

FIG. 1 is a diagram showing the whole structure of one example of the present invention.

FIG. 2 is a diagram showing the database structure of one example of the present invention.

FIG. 3 is a diagram showing the acquisition exception table structure of one example of the present invention.

FIG. 4 is a diagram showing the normal operation exception distribution table structure of one example of the present invention.

FIG. 5 is a flowchart showing the exception monitoring sequence of one example of the present invention.

FIG. 6 is a flowchart for forming the normal operation exception distribution table of the one example of the present invention.

FIG. 7 is a diagram for describing the abnormality judgment system based on the exception occurrence pattern of one example of the present invention.

### DETAILED DESCRIPTION

Embodiments of the present invention will be described in detail hereinafter with reference to the drawings. The present invention is by no means limited to the embodiments described hereinafter.

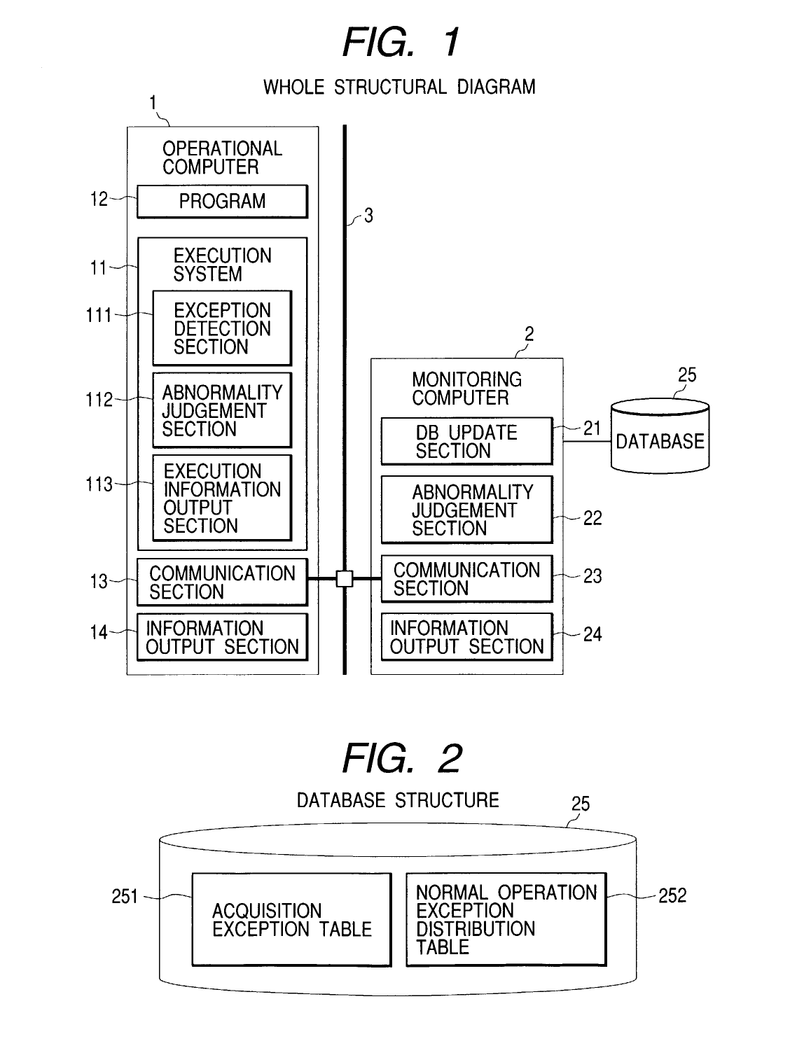

FIG. 1 is the whole structural diagram of one embodiment of the present invention. An operational computer (1) is connected to a monitoring computer (2) through a network (3). The operational computer (1) is provided with a program execution system (11), a communication section (13) for communication with the monitoring computer (2), and an information output section (14) for displaying and supplying a log and warning message.

An OS or an interpreter execution system may be used as the program execution system (11). The program execution system (11) is provided with an exception detection section (111) for detecting an exception that occurs during operation, an abnormality judgment section (112), and an execution information acquisition section (113). The exception detected by the exception detection section (111) includes the exception that occurs in the interpreter language in addition to the hardware exception and software exception. For example, the software exception includes the memory access violation and division by “0”.

The monitoring computer is provided with a communication section (23) for communication with the operational computer (1), a DB update section (21) for updating the database, an information output section (24) for displaying a screen and generating a log, an abnormality judgment section (22) for judging whether a received exception occurs during abnormality or not, and a database (25). The components described hereinabove will be described hereinafter.

A modified structure in which a data bus is used instead of the network (3) and the operational computer (1) and a module on the monitoring computer (2) are disposed on one computer to execute by means of the same one computer may be employed. Furthermore, another modified structure in which the two information output sections (14) and (24), namely the information output section (14) of the operational computer (1) and the information output section (24) of the monitoring computer (2), are not provided but only one information output section is provided and the one information output section is used commonly, or yet another modified structure in which an information output section of another computer is used additionally through the network (3) may be employed. In addition to the above, a modified structure in which the two abnormality judgment sections (112) and (22) disposed on the operational computer (1) and the monitoring computer (2) respectively as shown in FIG. 1 are not provided but only one abnormality judgment section is provided may be employed.

FIG. 2 shows the database structure. The database (25) has an acquisition exception table (251) and a normal operation exception distribution table (252).

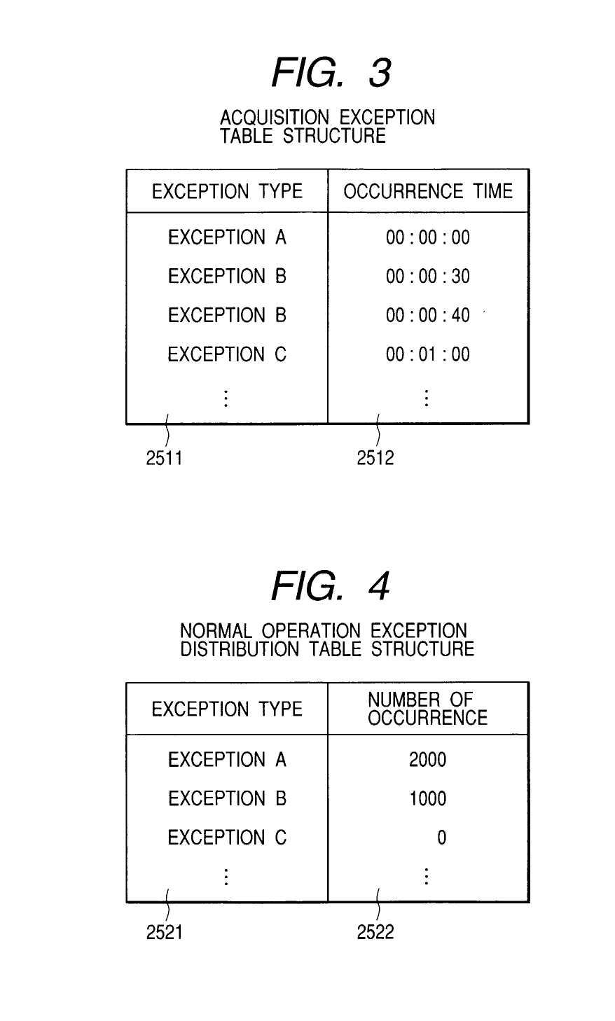

FIG. 3 is a diagram showing the acquisition exception table (251) structure. The acquisition exception table (251) holds the exception type (2511) and occurrence time (2512) when the exception occurs in the form of pair in time series. Every time when an exception occurs, the exception is written in the database under the control of the DB update section (21).

FIG. 4 is a diagram showing the normal operation exception distribution table (252) structure. The normal operation exception distribution table (252) records the exception type (2521) and the number of occurrence (2522) in the form of pair thereon.

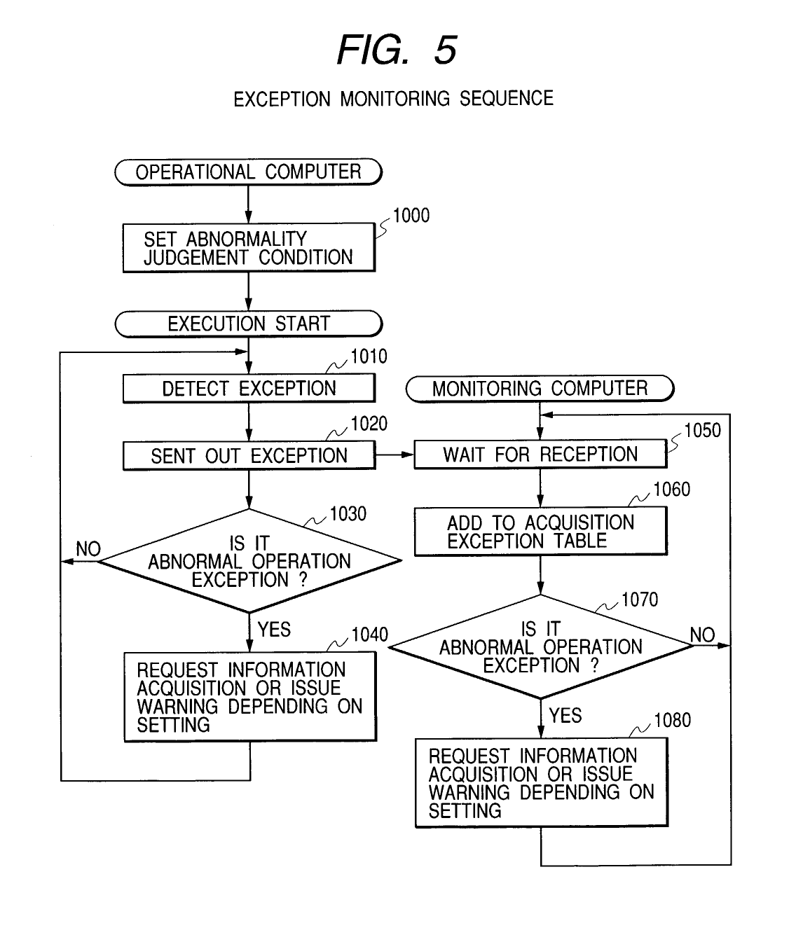

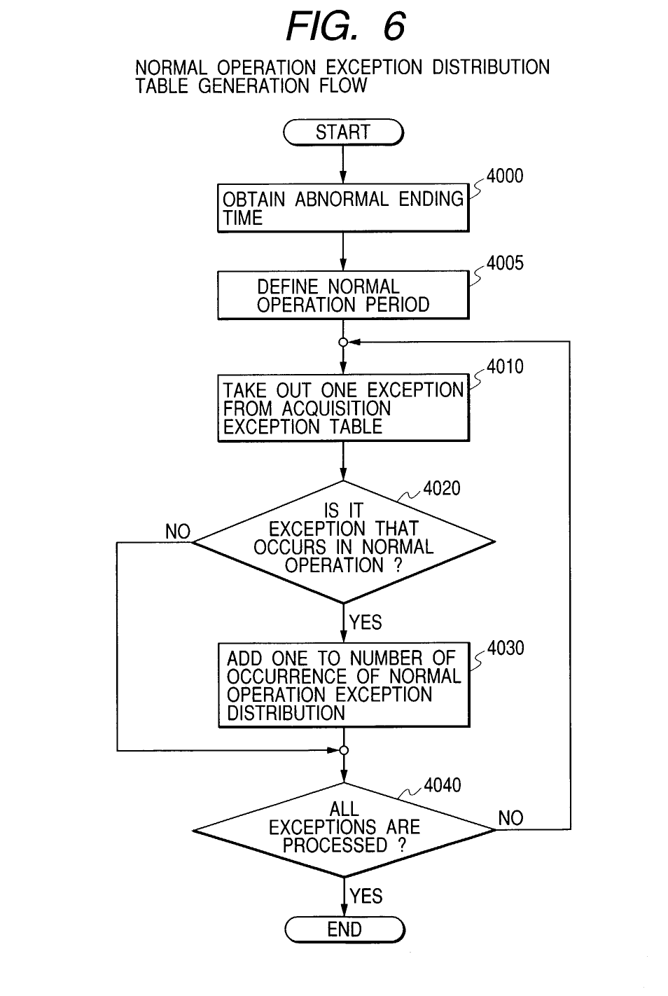

Next, the operation of the present invention will be described with reference to FIG. 5 that shows a flow of an exception monitoring means. Prior to execution of the program, an exception that is regarded as abnormality is set in the abnormality judgment section (112) of the operational computer (1) (step 1000). This step relates to FIG. 6. The border between the normal operation and abnormal operation is defined by a manager when the program error has ended based on the log information. The exception that is not found during the normal operation but found during abnormal operation is discriminated. The discriminated exception is stored in the abnormality judgment section (112) and abnormality judgment section (22).

During execution of the program, exceptions occur concomitantly with the execution. The exception is acquired by the exception detection section (111) (step 1010) and sent out to the abnormality judgment section (112). Furthermore, the exception is sent out to the monitoring computer (2) by use of the communication sections (14 and 24) (step 1020). When the abnormality judgment means (112) judges the exception as an abnormality exception (step 1030), the information output section (14) generates a dump for execution or generates a warning to a manager (step 1040) depending on the setting. The warning may be a mail transmitted to a manager or display of a warning message on a display of a console.

Upon receiving the exception (step 1050), the monitoring computer (2) adds the exception acquired by the DB update section (21) to the acquisition exception table (251) (step 1060). When the exception is judged as an abnormal exception (step 1070), a dump for execution is generated or a warning is generated depending on the setting (step 1080). The output result in the steps 1040 and 1080 are supplied to the information output means (14) and (24). The information generated as the dump for execution includes the information required for debugging of the program (12) such as program counter, stack pointer value, and number and time of generated thread.

The operational computer (1) and monitoring computer (2) are both used for judging abnormality of the exception in the above-mentioned sequence, however, in the case that any one of both computers has an abnormality judgment means, the portion for abnormality judgment may be omitted from the above-mentioned flow.

Next, the flow for generation of the normal operation exception distribution table shown in FIG. 6 will be described herein under. At first, the time when the error ends is acquired (step 4000), and the log data is generated. A manager determines the time of normal operation based on the data (step 4005). One exception is taken out from the acquisition exception table (251) (step 4010), whether the occurrence time (2512) is in the normal time or not is judged (step 4020), and the number of occurrence (2522) corresponding to the exception type (2521) is added to the normal operation exception distribution table (252) for the exception that occurs during normal operation (step 4030). The above-mentioned process is applied to all the exceptions to complete the normal operation exception distribution table (252) (step 4040). The process may be carried out every time when an error occurs to result in abnormal ending, or may be carried out periodically every time according to the time cycle set by a manager previously, or may be carried out when a manager judges it to be necessary. Furthermore, the period of normal operation described in the step 4005 may be defined by means of a method in which a threshold value of the period that is retroactive to the abnormality end is set previously and only the exceptions that occur before the threshold value are regarded as exceptions that occur during normal operation.

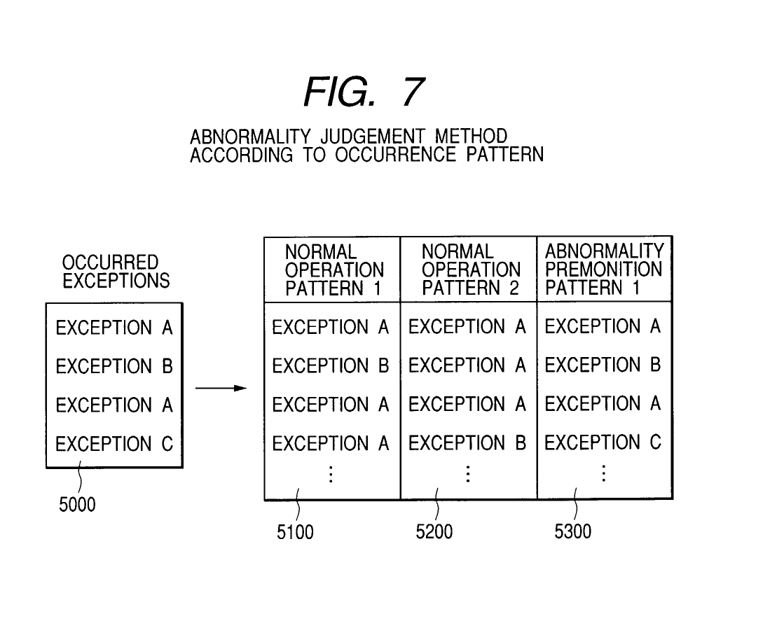

A method for judging whether the exception occurs during normal operation or gives a premonition of abnormality will be described with reference to FIG. 7. This method involves a method in which the exception type is judged according to the pattern based on the regularity of exception occurrence. The occurrence pattern (5100) of the normal operation exception is prepared based on the acquisition exception table (251). In the case that the execution is carried out a plurality of times and a plurality of occurrence patterns are obtained, these patterns are recorded as the normal pattern (5200). The pattern obtained when the abnormality occurs is recorded as the abnormal pattern (5300). The monitoring computer (2) is provided with a pattern preparation section for preparation of the normal operation pattern and abnormality premonition pattern, shown in FIG. 7, in the database though it is not shown in the drawing.

The abnormality occurrence is detected before the abnormality ends by use of either the judgment method according to the normal operation exception distribution table (252) or the judgment method according to the pattern. Otherwise, the judgment method according to the normal operation exception distribution table (252) and judgment method according to the pattern may be both used combinedly to improve the abnormality occurrence detection accuracy.

The exception occurrence distribution and the exception occurrence pattern are different for each program. Therefore, the above-mentioned exception occurrence distribution table, normal operation pattern, and abnormality premonition pattern are prepared for each program.

The occurrence of abnormality in operation is detected automatically though the process flow is not shown in the drawing. For example, in detection of an abnormality occurrence according to the exception occurrence distribution, when the exception C shown in FIG. 4 occurs, it is judged to be an abnormal exception because it does not occur during the normal operation. As described hereinabove, the exception that has not been judged to be an abnormal exception previously can be coped. Furthermore, by searching the occurrence pattern table by use of the occurred exception pattern 5000 shown in FIG. 7, it is found that the exception belongs to the abnormal premonition pattern. According to the above-mentioned technique, the occurrence of abnormal premonition pattern is detected even for the exception occurrence pattern that is so complicated as cannot be anticipated previously.

As described hereinabove, the premonition of abnormal operation of a program can be detected in early stage before the abnormality ends, the operation support in which a spare computer is made ready can be carried out if required, and as the result the computer execution can be stopped as early as possible.

Because the exception that results an end is different depending on the program, it is difficult to detect the error premonition only by monitoring occurrence of an exception. By applying the present example, the exception that occurs due to abnormal operation is discriminated correctly from the exception that occurs not due to abnormal operation by use of the distribution and pattern, and the highly reliable operation is realized. Because the execution log generated to be used for debugging is not generated when the system abnormality ends but can be generated when the abnormality is detected by means of a method of the present invention, it is easy to seize the cause of an error in comparison with the conventional method.

Furthermore, the debug information and warning are generated at the time when an exception just occurs for judgment by monitoring side, the abnormality judgment that involves complex process can be carried out without loading on the operational computer, and the abnormality can be detected with high accuracy. The operational computer is independent of the monitoring computer, and the practical function can be served depending on the environment and operation condition even if the abnormality is monitored by use of any one of the computers.

According to the present invention, the normal operation exception distribution, normal operation exception occurrence pattern, and abnormality premonition exception occurrence pattern can be obtained.

1. A computer system comprising:
a detection means for detecting an exception that occurs concomitantly with execution of a program; and
an exception distribution table preparation means for preparing an exception distribution table that shows the normal operation exception distribution based on the detected exception.

2. The computer system according to claim 1,
wherein said computer system has a memory means for storing detected exceptions in time series, and
wherein said exception distribution table preparation means prepares a table that stores the exception that occurs during normal operation and the number of occurrence of the exception out of the exceptions stored in said memory means.

3. The computer system according to claim 1, further comprising an abnormality judgment section for judging an exception distribution to be abnormal when an exception distribution that is different from said exception distribution is detected, and an information output section for carrying out the abnormality coping processing that has been set previously according to the output of said abnormality judgment section.

4. The computer system according to claim 1, further comprising an abnormality judgment section in which the exception to be regarded as abnormality determined based on said exception distribution table has been set to judge the exception to be abnormal when an exception that is regarded as abnormality is detected; and
an information output section for carrying out abnormality coping processing that has been set previously according to the output of said abnormality judgment section.

5. The computer system according to claim 4, wherein said output section generates a dump in execution and/or generates a warning according to the output of said abnormality judgment section.

6. The computer system according to claim 1, further comprising:
an abnormality judgment section in which the exception that does not occur in normal operation determined according to said exception distribution table has been set to judge the exception to be abnormal when the exception that does not occur in normal operation is detected; and
an information output section for generating a dump in execution and/or generating a warning according to the output of said abnormality judgment section.

7. A computer system comprising:
a detection means for detecting an exception that occurs concomitantly with execution of a program;
a memory means for storing a detected exception in time series; and
an exception occurrence pattern preparation means for preparing the normal operation exception occurrence pattern and the abnormal operation exception occurrence pattern from columns of exceptions stored in said memory means in time series.

8. A program execution monitoring method for a computer system comprising the steps of:
detecting an exception that occurs concomitantly with execution of a program;
preparing an exception distribution table that shows the normal operation exception distribution from detected exceptions, and when an exception occurs in execution of the same program as said program;
comparing the distribution of the exception with said exception distribution table to judge whether the exception is an abnormal operation or not.

9. A program execution monitoring method for computer system comprising the steps of:
detecting an exception that occurs concomitantly with execution of a program;
storing the detected exception in time series;
preparing the normal operation exception occurrence pattern and the abnormal operation exception occurrence pattern from columns of exceptions stored in time series; and
when an exception occurs in execution of the same program as said program, comparing the occurrence pattern of the exception with said normal operation exception occurrence pattern and/or said abnormal operation exception occurrence pattern to judge whether the exception is an abnormal operation or not.
